(19) United States
(12) Patent Application Publication
(10) Pub. No.: US 2022/0361445 A1
(43) Pub. Date: Nov. 17, 2022

(54) HAIR-PENETRATING MULTI-POINT SPRAYING APPARATUS FOR ANIMALS

(71) Applicant: KTC CO., Ltd., Wonju-si Gangwon-do (KR)

(72) Inventor: Eun Sang KIM, Wonju-si Gangwon-do (KR)

(21) Appl. No.: 17/862,416

(22) Filed: Jul. 12, 2022

Related U.S. Application Data
(63) Continuation-in-part of application No. PCT/KR2020/000633, filed on Jan. 13, 2020.

(51) Int. Cl. A01K 13/00; A46B 11/06

(52) U.S. Cl. CPC A01K 13/001; A46B 11/06; A46B 2200/1093

(57) ABSTRACT

A hair-penetrating multi-point spraying apparatus for animals with thick fur according to an embodiment of the present invention comprises: a fluid storage part for storing a fluid; a nozzle part provided so as to spray the fluid in close proximity to the skin of an animal with thick fur by means of a plurality of nozzles; and a spraying tool part for supplying the fluid in the fluid storage part to the nozzle part by pumping, The nozzle part has: a plurality of comb teeth for brushing the fur of an animal with thick fur; and a plurality of comb-teeth end nozzles protruding in the form of comb teeth so as to spray a fluid on the skin beneath the fur of the animal with thick fur.

### Technical Field

The disclosure relates to a multi-point spraying apparatus for spraying a fluid, and more particularly, to a hair-penetrating multi-point spraying apparatus for animals with thick fur, which can spray a fluid on the skin of an animal with thick fur stably and effectively without hindrance to fur or hair of the animal with thick fur.

### Background Art

In modern times, due to polluted air, epidermis (skin) of animals exposed to air is likely to be infected by germs or parasites, and skin damage and aging resulting therefrom are accelerated.

When such target epidermis is disinfected or cleansed, a chemical or a cleansing agent may be sprayed on the skin of an animal in a spraying method. However, in the case of animals with thick fur like a pet dog, their skin is covered with fur or hair, and a chemical or a cleansing agent may not be sprayed onto the epidermis or may not normally be sprayed since the skin is covered by fur or hair.

Accordingly, a method of cutting out fur or hair or parting hair by using hand or a tool to expose epidermis, and of spraying a chemical or a cleansing agent is normally employed, but this method may cause inconvenience and may be difficult to perform.

### DETAILED DESCRIPTION OF THE PRESENT DISCLOSURE

### Technical Objects

The disclosure has been developed in order to solve the problems of the related-art technology described above, and an object of the disclosure is to provide a multi-point fluid spraying apparatus which can spray a chemical or a cleansing agent on the skin of an animal uniformly and directly, without hindrance to fur or hair of an animal with thick fur.

### Technical Solving Means

According to an embodiment of the disclosure, there is provided a hair-penetrating multi-point spraying apparatus for animals including: a fluid storage part configured to store a fluid; a nozzle part configured to spray the fluid in the proximity of a skin of an animal through a plurality of nozzles; a spraying tool part configured to pump the fluid in the fluid storage part and to supply the fluid to the nozzle part, wherein the nozzle part includes a plurality of comb teeth for brushing fur of an animal with thick fur, and a plurality of comb- teeth end nozzles protruding in the form of comb teeth to spray the fluid on the skin beneath the fur of the animal.

### Advantageous Effects

According to an embodiment of the disclosure, the nozzle part of the multi-point spraying apparatus may perform not only the role of a spraying nozzle for spraying a fluid, but also the role of a comb or a brush for brushing fur or hair of an animal. Therefore, a series of operations of finding a position of skin to spray a fluid while brushing and sweeping fur or hair of an animal with thick fur, and bringing the comb-teeth end nozzles into close contact with the skin while pressing the skin or fur therearound, and directly spraying the fluid on the skin through a spray discharge pressure may be smoothly performed.

### BRIEF DESCRIPTION OF THE DRAWINGS

FIG. 1 is a perspective view of a hair-penetrating multi-point spraying apparatus for animals with thick fur according to an embodiment of the disclosure;

FIG. 2 is an exploded perspective view of some parts of the multi-point spraying apparatus according to an embodiment;

FIG. 3 is a cross-sectional view of some parts of the multi-point spraying apparatus according to an embodiment;

FIG. 4 is a perspective view of a nozzle part of the multi-point spraying apparatus according to an embodiment;

FIG. 5 is a front view of the nozzle part of the multi-point spraying apparatus according to an embodiment; and

FIG. 6 is a front view of a nozzle part of a multi-point spraying apparatus according to an alternative embodiment.

### BEST MODE FOR EMBODYING THE INVENTION

Exemplary embodiments will now be described more fully with reference to the accompanying drawings to clarify aspects, other aspects, features and advantages of the disclosure. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art.

It will be understood that when an element is referred to as being “on” another element, the element may be directly on another element or a third element therebetween. In the detailed descriptions, when a certain element is referred to as being connected (or coupled, secured, attached) to another element, the element may be directly connected (or coupled, secured, attached) to another element or may be indirectly connected (or coupled, secured, attached) to another element with a third element interposed therebetween. In the drawings of the specification, thicknesses of elements are exaggerated for easy understanding of technical features.

If the terms such as ‘first’ and ‘second’ are used to describe elements, these elements should not be limited by such terms. These terms are used for the purpose of distinguishing one element from another element only. The exemplary embodiments include their complementary embodiments.

As used herein, the singular forms are intended to include the plural forms as well, unless the context clearly indicates otherwise. It will be further understood that the terms “includes,” “is configured”, and “is comprised of” when used in this specification do not preclude the presence or addition of one or more other components.

Hereinafter, exemplary embodiments will be described in greater detail with reference to the accompanying drawings. The matters defined in the description are provided to assist in a comprehensive understanding of the exemplary embodiments. However, it is apparent that the exemplary embodiments can be carried out by those of ordinary skill in the art without those specifically defined matters. In the description of the exemplary embodiments, certain detailed explanations of related art are omitted when it is deemed that they may unnecessarily obscure the essence of the inventive concept.

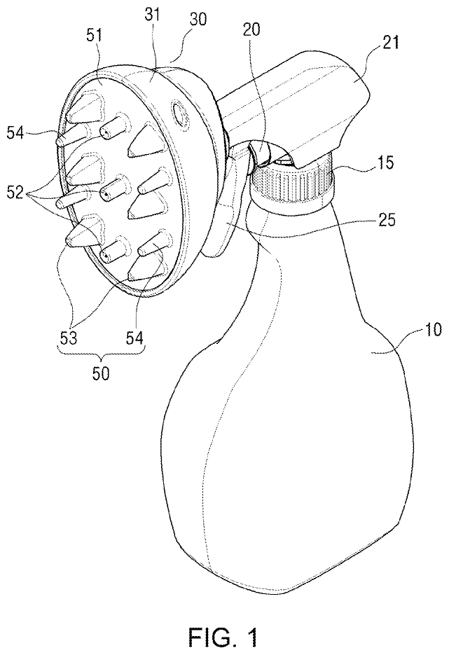

FIG. 1 is a perspective view schematically illustrating a hair-penetrating multi-point spraying apparatus for animals with thick fur (hereinafter, simply referred to as a “multi-point spraying apparatus” or “spraying apparatus”) according to an embodiment of the disclosure. Referring to the drawing, the hair-penetrating multi-point spraying apparatus for animals with thick fur according to an embodiment may include a fluid storage part 10, a spraying tool part 20, a pipe part 30, and a nozzle part 50.

The fluid storage part 10 is a member for storing a fluid to be sprayed through the nozzle part 50, and is configured in a container-like shape to have a fluid receiving space therein. For example, the fluid storage part 10 may contain a cleansing agent, a sanitizer, a disinfectant, or the like to cleanse, sanitize, or disinfect the skin of an animal with thick fur.

As shown in the drawing, in an embodiment, a lower portion of the fluid storage part 10 may be formed in a container-like shape having a wide cross-section so as to contain a fluid, and an upper portion thereof may be formed in a container-like shape of a relatively narrow cross section so as to be gripped by user's hand. However, this structure is merely an example and the shape of the fluid storage part 10 is not limited to a specific shape.

The spraying tool part 20 is a tool part for pumping the fluid stored in the fluid storage part 10 and supplying the fluid to the nozzle part 50. For example, when a user pulls a handle 25 protruding from the spraying tool part 20, the spraying tool part 20 may be configured to pump the fluid stored in the fluid storage part 10 and to supply the fluid to the nozzle part 50. A tool part housing 21 may be attached to an outside of the spraying tool part 20 and may be configured to cover the spraying tool part 20 at least in part.

The fluid storage part 10 and the spraying tool part 20 may be removably coupled to each other by a securing part 15, for example. For example, a screw thread may be formed on an inside of the securing part 15 and a screw thread engaged therewith may be formed on an outer circumference of an upper end of the fluid storage part 10, such that the fluid storage part 10 and the spraying tool part 20 may be secured to or separated from each other by rotating the securing part 15.

The pipe part 30 includes a pipe to supply the fluid pumped by the spraying tool part 20 to the nozzle part 50. In the illustrated embodiment, the nozzle part 50 may include a plurality of nozzles, and accordingly, the pipe part 30 may include a pipe to supply the fluid outputted from a fluid output end of the spraying tool part 20 to the plurality of nozzles of the nozzle part 50, respectively.

The nozzle part 50 may include a plurality of end nozzles for spraying a fluid through a plurality of spraying holes in the proximity of the skin of an animal with thick fur. For example, the nozzle part 50 includes a nozzle plate 51 which has a flat or curved surface, and a plurality of comb-teeth end nozzles 52 protruding from a surface of the nozzle plate 51. When the skin of an animal with thick fur is covered with thick fur (hair), it is preferable that the nozzles protrude from the nozzle plate 51 so as to directly spray the fluid on the skin. The comb-teeth end nozzles 52 are formed to protrude by a predetermined length like teeth of a comb, and nozzle holes are formed on leading ends of the protruding comb teeth. The comb-teeth end nozzle 52 in an embodiment may protrude from the nozzle plate 51 within a range from about 5 mm to 15 mm.

The nozzle part 50 may further include a plurality of comb teeth 54 and a plurality of fur parting pressure comb teeth 53 which have a larger diameter than that of the comb teeth 54. The comb teeth 54 may be for brushing fur of the animal with thick fur and may have a diameter smaller than that of the comb-teeth end nozzle 52, and a plurality of comb teeth 54 may be formed on the nozzle plate 51 at predetermined intervals or randomly. The nozzle part 50 includes the plurality of comb teeth 54, such that the nozzle part 50 serves as a sprayer to spray a fluid and also serves as a comb or a brush to brush fur of the animal with thick fur.

The fur parting pressure comb teeth 54 may be protruding members which have a larger diameter (or cross-sectional area) than that of the comb-teeth end nozzles 52 or the comb teeth 54, and preferably, may be formed adjacent to the comb-teeth end nozzles 52. The fur parting pressure comb teeth 53 may taper to have a cross-sectional area gradually reduced toward a leading end part in a protruding shape, and accordingly, a diameter (or a cross-sectional area) of the leading end part may be similar to an area of a leading end part of each of the comb teeth 54 or the comb-teeth end nozzles 52. In an embodiment, the fur parting pressure comb teeth 53 may furthest protrude from the nozzle plate 51, and for example, may protrude within a range from 10 mm to 20 mm.

When the comb-teeth end nozzles 52 are placed in close proximity of the skin of the animal with thick fur in order to spray the fluid, it may be difficult to directly spray the fluid on the skin since the skin is covered with the fur of the animal. However, in the disclosure, fur or hair may be brushed or swept by using the plurality of comb teeth 54 and the fur parting pressure comb teeth 53, and the leading end parts of the comb-teeth end nozzles 52 may be made to approach the skin. In this case, when the fur is pressed by the fur parting pressure comb teeth 53 while being brushed or swept, the fur parting pressure comb teeth 53 perform a role of parting and pressing the fur in the proximity of the comb-teeth lend nozzles 52, such that the comb-teeth end nozzles 52 come into close contact with the skin and directly spray the fluid on the skin.

In addition, after spraying the fluid on the skin of the animal from the comb-teeth end nozzles 52, the user may not directly detach the nozzle part 50 from the skin and may rub the skin with the nozzle part 50 for a predetermined time. In this case, the fur parting pressure comb teeth 53 presses while rubbing the skin area on which the fluid is sprayed, along with the comb teeth 54, thereby performing a role of making a chemical such as a disinfectant or a sanitizer well penetrate the skin.

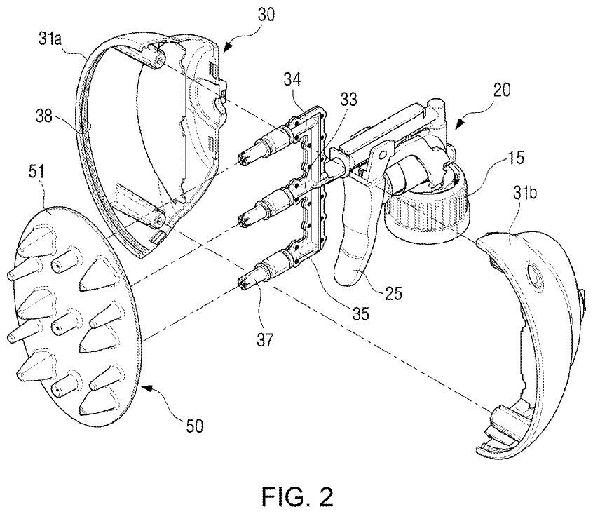

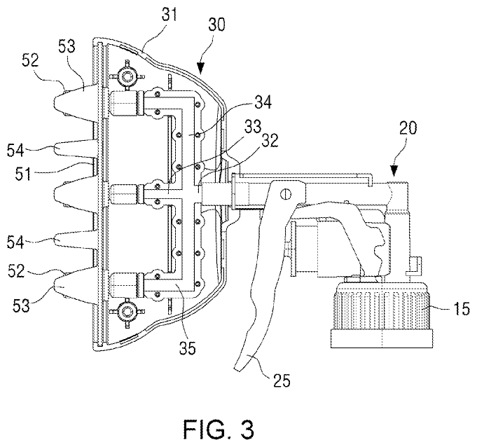

FIG. 2 is an exploded perspective view of some parts of the multi- point spraying apparatus according to an embodiment, and FIG. 3 schematically illustrates a side cross-sectional view of some parts of the multi-point spraying apparatus.

Referring to FIGS. 2 and 3, the spraying tool part 20 is a device for pumping the fluid in the fluid storage part 10 and supplying the fluid to the nozzle part 50, and for example, may include a cylinder 21, a piston 22, and the handle 25. The piston 22 may be partially inserted into the cylinder 21, and may reciprocate inside the cylinder 21 by a user pulling the handle 25. In an embodiment, the cylinder 21 may include a suction pipe (not shown) to draw in the fluid in the fluid storage part 10, a discharge pipe (not shown) to discharge the fluid in the cylinder 21 to the pipe part 30, and check valves installed in the suction pipe and the discharge pipe, respectively, and the fluid in the fluid storage part 10 may be drawn into the cylinder 21 every time the piston 22 reciprocates, and then, may be discharged to the discharge pipe.

The fluid discharged from the discharge pipe of the spraying tool part 20 may be conveyed to the nozzle part 50 through pipes of the pipe part 30. In an embodiment, the pipe part 30 may include a main pipe 32 and a plurality of branch pipes 33, 34, 35 branching from one end of the main pipe 3. In the illustrated embodiment, the first branch pipe 33 among the branch pipes may be linearly extended from the main pipe 32 and stretched to the comb-teeth end nozzle 52 of the nozzle part 50. The other branch pipes, the second and third branch pipes 34, 35, may branch from the main pipe 32 and may be stretched to the comb-teeth end nozzles 52 along paths longer than the first branch pipe 33.

In the illustrated embodiment, three comb-teeth end nozzles 52 of the nozzle part 50 are illustrated as being arranged vertically (on the drawing), and in this case, the first branch pipe 33 may be connected with the middle nozzle 52 among the three comb-teeth end nozzles 52, the upper second branch pipe 34 may be connected with the upper nozzle 52, and the lower third branch pipe 35 may be connected with the lower nozzle 52. However, it will be understood that, when the nozzle part 50 includes more comb-teeth end nozzles 52, the pipe part 40 may include more branch pipes.

When the fluid in the main pipe 32 branches and flows into the plurality of branch pipes 33, 34, 35, it is preferable that the respective comb- teeth end nozzles 52 spray the fluid under the same spraying pressure. To achieve this, it is preferable to set respective widths (diameters) of the pipes by considering lengths, shapes, and branch forms of the first branch pipe 33 on the middle portion and the second and third branch pipes 34, 35 on the upper and lower portions. For example, in the illustrated embodiment, the first branch pipe 33 on the middle portion has a relatively short length and thus has a low fluid resistance, whereas the second and third branch pipes 34, 35 have relatively long lengths and have a “ [symbol] ”-shaped bending portion, respectively, and have a high fluid resistance. Considering this, it is preferable that the diameters of the second and third branch pipes 34, 35 are formed larger than that of the first branch pipe 33.

As shown in FIG. 2, the pipes 32, 33, 34, 35 of the pipe part 30 may be disposed in a pipe part housing 31, and the pipe part housing 31 may be divided into two parts 31a, 31b for convenience of coupling. A recess part 38 may be formed on an inner circumference of an end of the pipe part housing 31 which is coupled with the nozzle part 50, and an edge of the nozzle plate 51 of the nozzle part 40 may be inserted into and seated in the recess part 38, such that the nozzle part 50 is coupled to the pipe part housing 31.

In addition, a nozzle tip 37 may be secured to an end of each of the branch pipes 32, 34, 35 to spray the fluid under a high pressure, and the respective nozzle tips 37 may be inserted into inner spaces of the respective comb-teeth end nozzles 52 of the nozzle part 50, thereby being coupled with the nozzle part 50. Due to the above-described configuration, the nozzle part 50 may be removably coupled to the pipe part 30, and the nozzle part 50 may be removed from the pipe part 30 and may be replaced when necessary.

The nozzle tip 37 may be formed with a metallic material, and may have one or more discharge ports formed at an end thereof to spray the fluid. In an embodiment, the nozzle tip 37 may include a plurality of discharge ports and each of the discharge ports may be formed of a penetrating hole of a predetermined diameter or less in order to increase a discharge pressure of the sprayed fluid. For example, each of the discharge ports at the end of the nozzle tip 37 may have a diameter of a few micrometers to hundreds of micrometers, and accordingly, when the fluid is sprayed under a strong discharge pressure, the fluid may be decomposed into minute particles of a few micrometers to tens of micrometers and may be sprayed, and, when the fluid is sprayed on the skin of an animal, the fluid may more easily penetrate the skin. A nozzle hole of the leading end part of the comb-teeth end nozzle 52 may be configured to cover a leading end part of the nozzle tip 37, and preferably, may have a hole size enough not to hinder the flow of the fluid sprayed from the discharge ports of the nozzle tip 37.

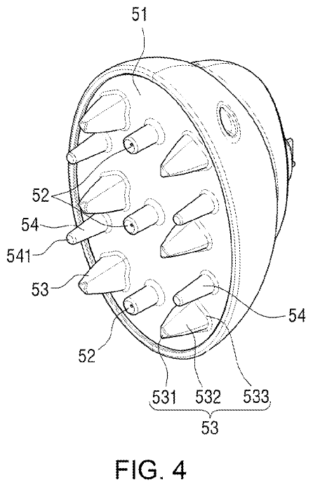

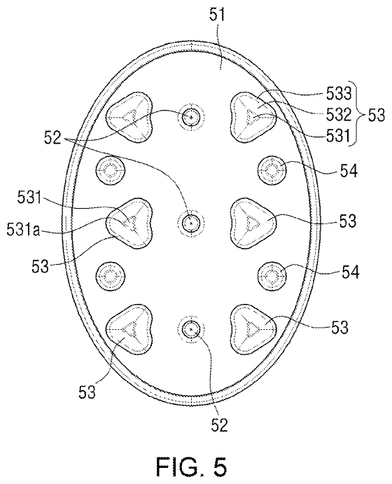

FIGS. 4 and 5 schematically illustrate a perspective view and a front view of the nozzle part 50 of the multi-point spraying apparatus according to an embodiment.

Referring to the drawings, the nozzle plate 51 of the nozzle part 50 includes the plurality of comb-teeth end nozzles 52, the fur parting pressure comb teeth 53, and the comb teeth 54 which protrude from the surface thereof. In an embodiment, the comb-teeth end nozzles 52, the fur parting pressure comb teeth 53, and the comb teeth 54 may be integrally formed with the nozzle plate 51, or may be formed individually and then may be attached to the nozzle plate 51 to be integrally formed therewith.

The fur parting pressure comb teeth 53 and the comb teeth 54 may be formed with a material having elasticity. For example, the fur parting pressure comb teeth 53 and the comb teeth 54 may be manufactured with a material of high molecular plastic such as polyethylene (PE), polypropylene (PP), polyurethane (PU), polyethylene terephthalate (PET), or the like, and, when the nozzle part 50 is pressed in close contact with the skin of an animal, the fur parting pressure comb teeth 53 and the comb teeth 54 may be slightly bent due to elasticity, so that the skin of the animal may be prevented from being damaged.

In an embodiment of the disclosure, the nozzle part 50 may function as a spraying nozzle to spray a fluid, but preferably, may serve as a comb or a brush to brush fur of an animal with thick fur in order to spray the fluid on the skin of the animal effectively. To achieve this, the nozzle part 50 may be configured according to the following requirements.

First, the nozzle part 50 may include the fur parting pressure comb teeth 53 having a relatively large cross-sectional area, and preferably, the fur parting pressure comb teeth 53 are disposed adjacent to the left and right of the comb-teeth end nozzle 52.

As shown in the drawing, the fur parting pressure comb teeth 53 may protrude from the nozzle plate 51, and may include a leading end part 531, a body part 532, and a base part 533. The body part 532 may be a body of the fur parting pressure comb tooth 53, and the base part 533 is a part for connecting the body part 532 and the surface of the nozzle plate 51. The leading end part 531 is a most protruding end of the body part 532, and may be formed to have a gently curved surface or a flat surface.

The fur parting pressure comb tooth 53 may be formed in a tapering shape, such that the cross-sectional area of the base part 533 is largest and the cross-sectional area is gradually reduced toward the leading end part 531. The cross-sectional area of the leading end part 531 may be similar to the cross- sectional area of each of the comb teeth 54 or the comb- teeth end nozzles 52, and the cross-sectional area of the base part 533 may be ten to fifteen times larger than the cross-sectional area of the leading end part 531.

In an embodiment, the fur parting pressure comb teeth 53 are disposed adjacent to the comb-teeth end nozzles 52. For example, in the illustrated embodiment, the fur parting pressure comb teeth 53 may be disposed on the left and right sides of the nozzle 52 with respect to one comb-teeth end nozzle 52 (on FIG. 5), respectively. For example, each of the fur parting pressure comb teeth 53 may be spaced apart from the left or right side of the nozzle 52 by 5 mm to 15 mm.

As described above, when the fur parting pressure comb teeth 53 having a relatively large cross-sectional area are disposed adjacent to the left and right of the comb-teeth end nozzle 52, and the comb teeth 54 are disposed therearound, a user may brush or sweep the fur of an animal by using the fur parting pressure comb teeth 53 and the comb teeth 54, and may part and press the skin of the animal or the fur on the skin by using the fur parting pressure comb teeth 53, such that the fluid may be directly sprayed on the skin by the comb-teeth end nozzles 52 being in close contact with the skin.

Second, the fur parting pressure comb teeth 53 may be formed in a tapering shape, and the leading end part of each of the fur parting pressure comb teeth 53 may have a substantially triangular cross section, and a corner (vertex) of the leading end part may face the opposite direction of the comb- teeth end nozzle 52.

Each of the fur parting pressure comb teeth 53 may be formed in a tapering shape to have the cross-sectional area gradually reduced from the base part 533 toward the leading end part 531, and the diameter (or cross- sectional area) of the leading end part 531 may be similar to the cross-sectional area of the comb teeth 54 or the comb-teeth end nozzles 53. Accordingly, the body part 532 of each of the fur parting pressure comb teeth 53 performs a role of pressing skin or fur of an animal, and simultaneously, the leading end part 531 may perform the role of a brush of brushing or sweeping fur along with the comb teeth 54.

In this case, the leading end part 531 may have a substantially triangular cross section as shown in FIG. 5, and at least one corner 531a of the triangular shape may be configured to face the opposite direction of the comb-teeth end nozzle 52. That is, referring to FIG. 5, the corner 531a of each of the fur parting pressure comb teeth 53 disposed on the left side of the comb-teeth end nozzles 52 may be configured to face the left side, and the corner 531a of each of the fur parting pressure comb teeth 53 disposed on the right side may be configured to face the right side. Accordingly, when the user brushes or sweeps the fur of an animal with thick fur while moving the multi-point spraying apparatus horizontally, hindrance to combing by the fur parting pressure comb teeth 53 may be minimized.

Third, the fur parting pressure comb teeth 53 and the comb teeth 54 may further protrude than the comb-teeth end nozzles 52.

In an embodiment, the comb-teeth end nozzles 52 may protrude from the surface of the nozzle plate 51 by about 5 mm to 15 mm. Since the fur parting pressure comb teeth 53 should press skin or fur therearound before the comb-teeth end nozzles 52 come into contact with the skin, the fur parting pressure comb teeth 53 may further protrude than the comb-teeth end nozzles 52. For example, the fur parting pressure comb teeth 53 may protrude by 10 mm to 20 mm. Since the comb teeth 54 performs the role of brushing along with the fur parting pressure comb teeth 53, the comb tooth 54 may have the same protruding height as that of the fur parting pressure comb teeth 53, for example, may protrude by 10 mm to 20 mm. In this case, a difference in the height between the comb-teeth end nozzles 52 and the fur parting pressure comb teeth 53 may be about 2 mm to 5 mm, and accordingly, the fluid may be sprayed on a large area of the skin with the comb-teeth end nozzles 52 not being in close contact with the skin and being spaced apart therefrom by a distance.

As described above, the nozzle part 50 according to the disclosure may perform not only the role of a comb-teeth end spraying nozzle for spraying a fluid, but also the role of a comb or a brush for brushing fur or hair of an animal. Therefore, a series of operations of finding a position of skin to spray a fluid while brushing and sweeping fur or hair of an animal with thick fur, and bringing the comb-teeth end nozzles 52 into close contact with the skin while pressing the skin or fur therearound, and directly spraying the fluid on the skin may be smoothly performed.

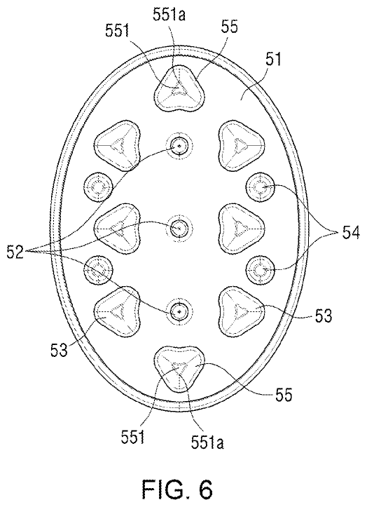

FIG. 6 schematically illustrates a front surface of a nozzle part of a multi-point spraying apparatus according to an alternative embodiment.

Referring to the drawing, the nozzle part of the alternative embodiment may include a nozzle plate 51 and a plurality of comb-teeth end nozzles 52, a plurality of fur parting pressure comb teeth 53, and a plurality of comb teeth 54 which protrude from a surface of the nozzle plate 51, and respective elements of the comb-teeth end nozzles 52, the fur parting pressure comb teeth 53, and the comb teeth 54 have the same or similar configurations and perform the same or similar roles as the elements in FIGS. 1 to 5, and thus a redundant explanation thereof is omitted.

In the embodiment of FIG. 6, the nozzle part (with reference to the drawing) may further include additional fur parting pressure comb teeth 55 formed on an upper portion and a lower portion of the nozzle plate 51, respectively. That is, the fur parting pressure comb tooth 55 may be additionally formed at a predetermined distance above the comb-teeth end nozzle 52 disposed on an uppermost portion of the nozzle plate 51, and the fur parting pressure comb tooth 55 may be additionally formed at a predetermined distance below the comb-teeth end nozzle 52 disposed on a lowermost portion of the nozzle plate 51.

A leading end part 551 of each of the fur parting pressure comb teeth 55 additionally formed on the upper portion and the lower portion, respectively, may have a substantially triangular cross section, and at least one corner 551a of the triangular shape may be formed to face the opposite direction of the comb-teeth end nozzle 52. That is, referring to FIG. 6, the corner 551a of the fur parting pressure comb tooth 55 additionally formed on the upper portion (on the drawing) may be configured to face upward, and the corner 551a of the fur parting pressure comb tooth 55 disposed on the lower portion may be configured to face downward, and, when a user brushes or sweeps fur of an animal with thick fur while moving the multi-point spraying apparatus horizontally or vertically, hindrance to combing by the fur parting pressure comb teeth 53, 55 may be minimized.

It will be understood by a person skilled in the art that various changes and modifications can be made based on the above descriptions of the disclosure. For example, although it is illustrated that the nozzle part 50 includes a specific number of comb-teeth end nozzles 52, a specific number of fur parting pressure nozzles 53, and a specific number of comb teeth 54, the disclosure is not limited thereto, and according to a specific embodiment, the number of comb-teeth end nozzles 52, the number of fur parting pressure nozzles 53, and the number of comb teeth 54 may increase or decrease. Therefore, the scope of the disclosure is defined not by the detailed description of the embodiments but by the appended claims and equivalents thereto.

What is claimed is:

1. A hair-penetrating multi-point spraying apparatus for animals he apparatus comprising:
a fluid storage part configured to store a fluid;
a nozzle part configured to spray the fluid on a skin of an animal through a plurality of nozzles;
a spraying tool part configured to pump the fluid in the fluid storage part and to supply the fluid to the nozzle part,
wherein the nozzle part comprises a plurality of comb teeth for brushing fur of an animal, and a plurality of comb-teeth end nozzles protruding in the form of comb teeth to spray the fluid on the skin beneath the fur of the animal.

2. The apparatus of claim 1, further comprising a pipe part configured to supply the fluid pumped by the spraying tool part to the plurality of comb-teeth end nozzles of the nozzle part.

3. The apparatus of claim 2, wherein the nozzle part comprises a nozzle plate which has a flat or curved shape, and the plurality of comb teeth and the plurality of comb-teeth end nozzles are formed to protrude from a surface of the nozzle plate by predetermined lengths.

4. The apparatus of claim 3, wherein the pipe part comprises:
a main pipe connected to a fluid output pipe of the spraying tool part;
a first branch pipe linearly extended from the main pipe; and
a plurality of second branch pipes branching from the main pipe and having a longer length than that of the first branch pipe.

5. The apparatus f claim 4, wherein a nozzle tip is attached to an end of each of the first and second branch pipes, and the nozzle tip is inserted into and coupled to an inside of each of the comb-teeth end nozzles.

6. The apparatus of claim 1, wherein the nozzle part further comprises a plurality of fur parting pressure comb teeth having a larger cross- sectional area than those of the comb teeth and the comb-teeth end nozzles.
